(19) United States
(12) Patent Application Publication
(10) Pub. No.: US 2003/0144845 A1
(43) Pub. Date: Jul. 31, 2003

(54) Voice command interpreter with dialog focus tracking function and voice command interpreting method

(75) Inventor: Jae-won Lee, Seoul (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Kyungki-do (KR)

(21) Appl. No.: 10/352,855

(22) Filed: Jan. 29, 2003

(30) Foreign Application Priority Data
Jan. 29, 2002 (KR) 2002-5201

(51) Int. Cl. G10L 21/00

(52) U.S. Cl. 704/275

(57) ABSTRACT

A voice command interpreter and a method of interpreting a voice command of a user are provided. Accordingly, users do not need to indicate the name of a control target device every time, and a command word to be spoken by users can be shortened.

### BACKGROUND OF THE INVENTION

This application claims the priority of Korean Patent Application No. 2002-5201, filed on Jan. 29, 2002, in the Korean Intellectual Property Office, the disclosure of which is incorporated herein in its entirety by reference.

1. Field of the Invention

The present invention relates to a voice command interpreter and a voice command interpreting method, and more particularly, to a method and an apparatus for interpreting a voice command received from a user for controlling a plurality of devices in order to provide to an apparatus which controls the devices information on devices to be controlled and control command information.

2. Description of the Related Art

In the prior art, various devices, such as TVs, VCRs, audio recorders, refrigerators, and the like, are usually controlled by respective corresponding remote controllers or a single integrated remote controller which integrates the functions of remote controllers. There is a trend to connect such devices to a network, and a demand for a convenient interface to control the devices connected to a network increases.

A multiple device control method using a voice command has been developed as a method of controlling the devices connected to a network. The following two methods are examples of conventional methods of controlling multiple devices using a voice command.

In the first method, device names must be specified in a command word in order to eliminate ambiguity in the interpretation of the command word. For example, the actual operations and the target devices of the operations are specified, like “turn on the TV”, “turn down the volume of the TV”, “turn on the audio recorder”, or “turn down the volume of the audio recorder”. However, the first method is bothersome to users since the users have to repeat the device names that are the targets of operations.

In the second method, user confirmation is used to eliminate ambiguity in the interpretation of the command word. To be more specific, in the second method, if a command from the user is determined to be ambiguous, additional voice information relating to which device a user will operate is received. Like the first method, the second method is bothersome to users because the users are requested to utter additional information.

### SUMMARY OF THE INVENTION

The present invention provides a voice command interpreter and a voice command interpreting method by which even when a command word of a user is ambiguous, the command word is interpreted using a function of tracking the focus of a user dialog in order to control a device.

According to an aspect of the present invention, there is provided a voice command interpreter used to control a predetermined electronic device, the voice command interpreter including a voice recognition unit, a command word interpretation unit, a control target extractor, a focus manager, and a device controller. The voice recognition unit recognizes a voice command of a user as a command sentence for the predetermined electronic device. The command word interpretation unit extracts device data, control operation attributes, and a vocabulary command word from the command sentence received from the voice recognition unit. The control target extractor extracts device data or control operation attribute data based on the vocabulary command word data and the stored focus data if no device data or no control operation attribute data is received from the command word interpretation unit. The focus manager updates the focus data with the extracted device data and the extracted control operation attribute data. The device controller outputs the control target device data corresponding to the focus data and the vocabulary command word data corresponding to the vocabulary command word to the outside.

According to another aspect of the present invention, there is provided a method of interpreting a voice command of a user in order to control a predetermined electronic device. In this method, first, a voice command of a user is recognized as a command sentence. Next, device data, control operation attribute data, and vocabulary command word data are extracted from the command sentence. Thereafter, device data or control operation attribute data is produced based on the vocabulary command word data and pre-set focus data if no device data or no control operation attribute data is extracted from the command sentence. Then, the focus data is updated with the produced control target device data and the produced control operation attribute data. Finally, the control target device data corresponding to the focus data and the vocabulary command word data corresponding to the vocabulary command word are output to the outside.

### BRIEF DESCRIPTION OF THE DRAWINGS

The above and other features and advantages of the present invention will become more apparent by describing in detail exemplary embodiments thereof with reference to the attached drawings in which:

FIG. 1 shows a data structure of a command word according to a preferred embodiment of the present invention;

FIGS. 2A and 2B show database tables in which the data structure of a command word of FIG. 1 is represented;

FIG. 3 is a block diagram of a voice command interpreter according to a preferred embodiment of the present invention;

FIG. 4 is a flowchart illustrating a method of interpreting a voice command according to a preferred embodiment of the present invention; and

FIG. 5 is a flowchart illustrating a method of extracting devices to be controlled according to a preferred embodiment of the present invention.

### DETAILED DESCRIPTION OF THE INVENTION

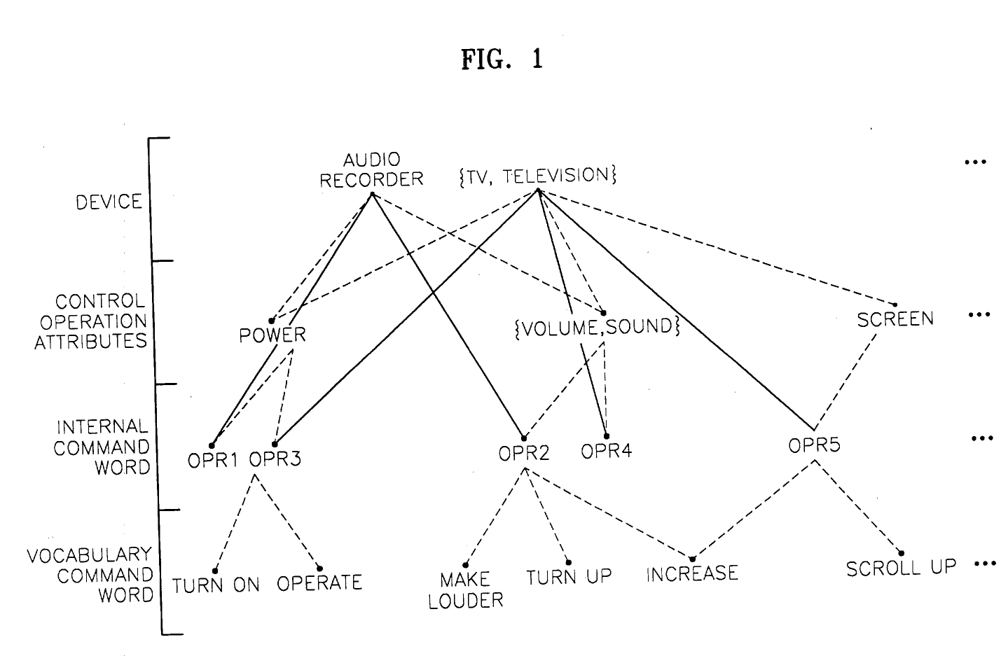

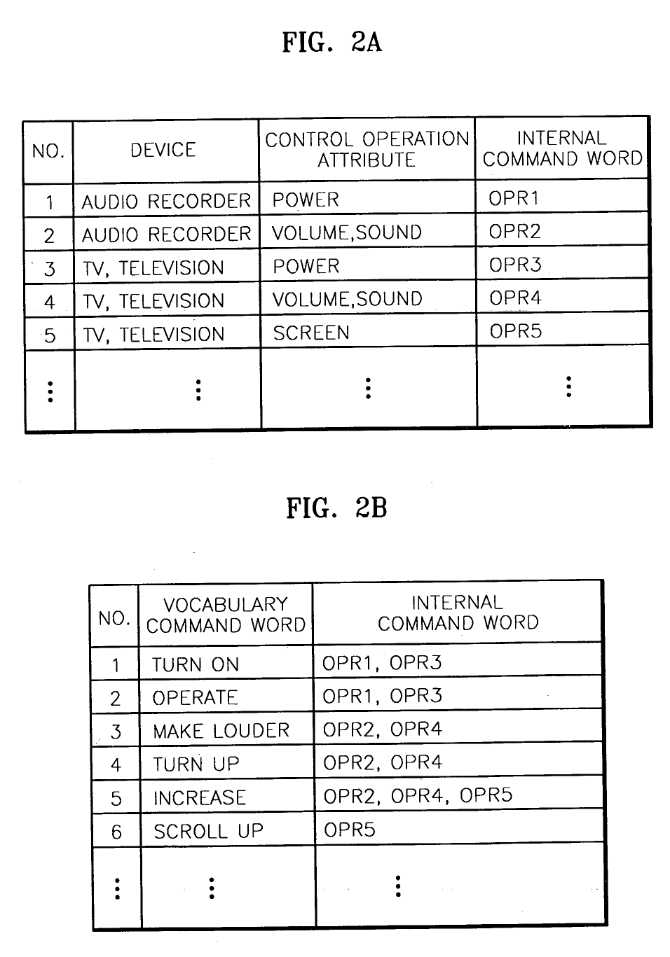

Referring to FIG. 1, data on a command word is comprised of data on a vocabulary command word, data on an internal command word, data on a device, and data on a control operation attribute. The vocabulary command word data denotes the original form of a command word of a user, and the internal command word data denotes a command word from which ambiguity in the device data and control operation attribute data of the command word of a user has been removed. The device data and the control operation attribute data of a command word are used by a voice command interpreter according to the present invention. The device data denotes a predetermined physical device to be controlled, and the control operation attribute data denotes an attribute of a device which is directly controlled. For example, if a command word “turn up the volume of the TV” is received from a user, “TV” corresponds to the device data, “volume” corresponds to the control operation attribute data, and “turn up” corresponds to the vocabulary command word data. Referring to FIGS. 2A and 2B, an internal command word data corresponding to the device data, control operation attribute data, and vocabulary command word data of the above example is “OPR4”.

The data structure of a command word of FIG. 1 will now be described in detail. A plurality of devices, such as, an audio recorder, a TV (television), etc., may exist. Also, a plurality of control operation attributes associated with the above devices may exist. In FIG. 1, examples of the control operation attributes are “power”, “volume (or sound)”, and “screen”. The control operation attributes “power” and “volume (or sound)” are associated with the device data “audio recorder” and “TV (or television)”. The control operation attribute “screen” is only associated with the device data “TV”. Examples of internal command word data include “OPR1”, “OPR2”, “OPR3”, “OPR4”, and “OPR5”. “OPR1” is associated with the control operation attribute “power” of the device “audio recorder”. “OPR2” is associated with the control operation attribute “volume” of the device “audio recorder”. “OPR3” is associated with the control operation attribute “power” of the device “TV (or television)”. “OPR4” is associated with the control operation attribute “volume (or sound)” of the device “TV (or television)”. “OPR5” is associated with the control operation attribute “screen” of the device “TV (or television)”.

Each of the control operation attributes corresponds to at least one vocabulary command word. “OPR1” and “OPR3” are associated with vocabulary command words “turn on” and “operate”. “OPR2” and “OPR4” are associated with vocabulary command words “make louder”, “turn up” and “increase”. “OPR5” is associated with a vocabulary command word “scroll up”.

A table of a command word database (DB) based on the above associations can be written as shown in FIGS. 2A and 2B.

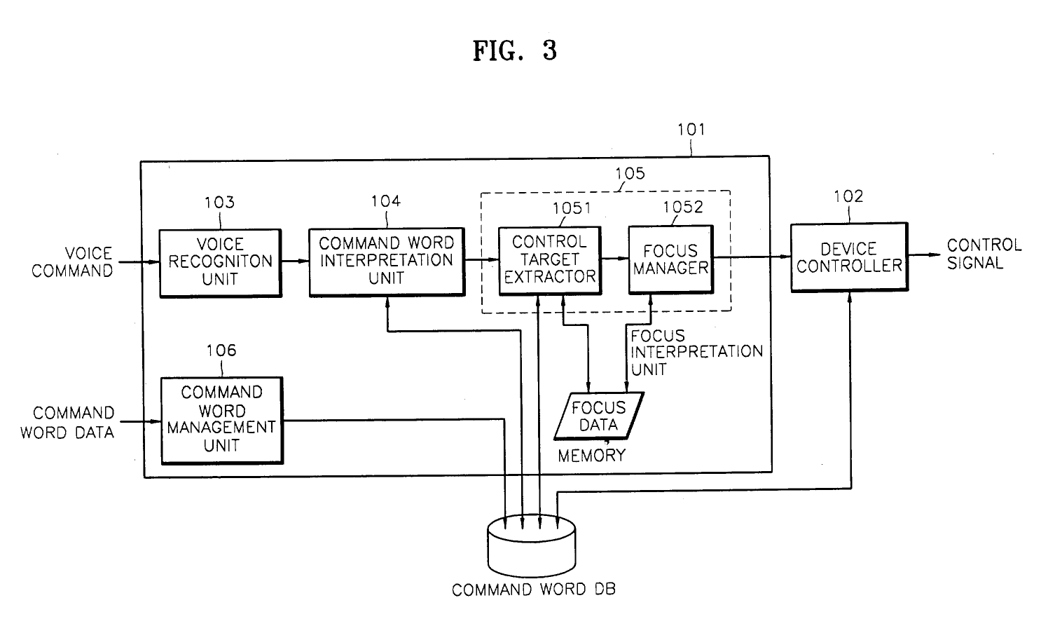

FIG. 3 is a block diagram of a voice command interpreter according to a preferred embodiment of the present invention. The voice command interpreter 101 includes a voice recognition unit 103, a command word interpretation unit 104, and a focus interpretation unit 105. The voice command interpreter 101 can further include a command word management unit 106 for managing a command word DB, which is referred to when a command word is interpreted or a device to be controlled is extracted from the command word.

The voice recognition unit 103 recognizes a voice of a user to be a command sentence and provides the recognized command sentence to the command word interpretation unit 104. Regarding the above voice recognition method performed in the voice recognition unit 103, many conventional techniques have been introduced. Hence, the voice recognition method will not be described.

The command word interpretation unit 104 interprets the recognized command sentence received from the voice recognition unit 103 by breaking down the recognized command sentence into parts of speech in order to extract data on a device to be controlled, data on a control operation attribute, and data on a vocabulary command word. Since there are many conventional methods of interpreting a predetermined sentence in units of a part of speech, they will not be described in this specification. During the interpretation of the command sentence, the command word interpretation unit 104 can become aware of data on a command word that can be used by the user by referring to the command word DB as shown in FIG. 3.

The focus interpretation unit 105 is composed of a control target extractor 1051 and a focus manager 1052. The control target extractor 1051 receives the results of the interpretation of the command sentence from the command word interpretation unit 104 and determines whether the result of the command sentence interpretation is ambiguous. That is, the interpretation result is determined to be ambiguous if the received interpretation result does not include device data or control operation attribute data. If the vocabulary command word data is “make louder”, and no device data is provided, which corresponds to an ambiguous case, the internal command words corresponding to the above case are “OPR2” and “OPR4” in the table of FIG. 2B.

If the command sentence produced from the voice command of the user is ambiguous, the control target extractor 1051 removes the ambiguity from the command sentence based on vocabulary command word data, focus data stored in a memory, and command word data stored in the command word DB. Here, the focus data denotes data on a device to be controlled by a user and/or data on a control operation attribute. For example, the focus data can be single data, for example, device data “TV” or control operation attribute data “power”. Preferably, the focus data can be a combination of device data and control operation attribute data, such as “TV_power”.

If the focus data stored in the memory is “TV”, the vocabulary command word data provided by the command word interpretation unit 104 is “make louder”, and the device data and the control operation attribute data are not provided, ambiguity is removed from the command sentence of the voice command by extracting the device data and the control operation attribute data. To be more specific, first, the table of FIG. 2B is searched for internal command word data “OPR2” and “OPR4” which correspond to the vocabulary command word “make louder”. Referring to the table of FIG. 2A, a data record whose device data is “TV” and internal command word data is “OPR2” or “OPR4” has a control operation attribute “volume, sound”. Accordingly, the complete form of the command sentence is “make the volume or sound of the TV louder”.

On the other hand, if the vocabulary command word is “increase”, internal command word data corresponding to the vocabulary command word “increase” are “OPR2”, “OPR4”, and “OPR5”. Referring to the table of FIG. 2A, the fourth and fifth data records are detected as records having device data “TV” and internal command word data “OPR2”, “OPR4”, or “OPR5”. That is, two control operation attributes “volume or sound” and “screen” are detected. In this case, one of the two control operation attributes cannot be automatically selected. Thus, the two control operation attributes are provided to the user, and the user determines one out of the two control operation attributes.

When the control target extractor 1051 completes a command sentence through the above-described process, it provides the device data, the control operation attribute data, and command data (vocabulary command word data or internal command word data) to the focus manager 1052.

The focus manager 1052 updates the focus data with the device data and control operation attribute data received from the control target extractor 1051 and provides the device data and the internal command word data to a device controller 102 so that it can use this data to control a predetermined device.

The voice command interpreter 101 can further include a command word management unit 106 for adding command word data to the command word DB, deleting command word data from the command word DB, and updating the command word data stored in the command word DB.

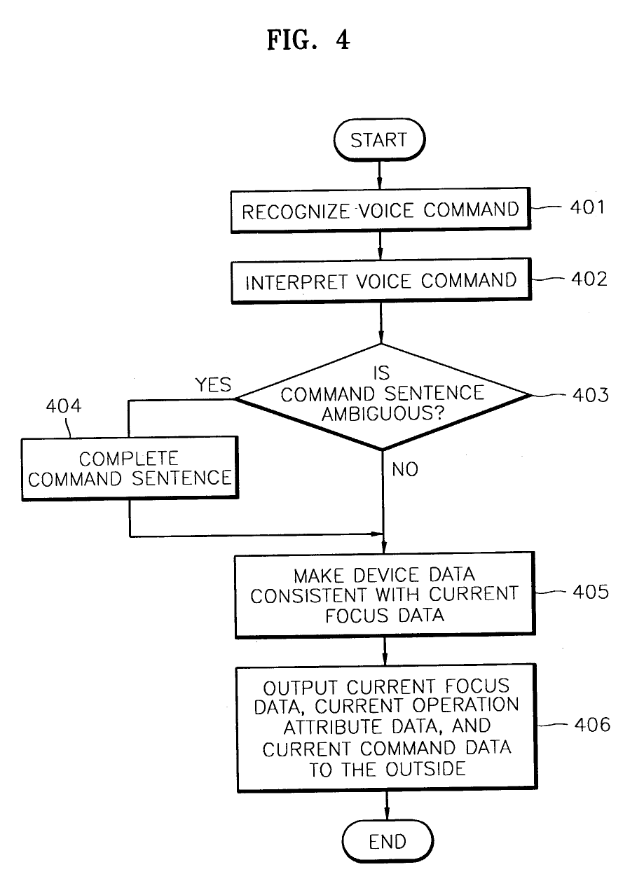

FIG. 4 is a flowchart illustrating a method of interpreting a voice command according to a preferred embodiment of the present invention. In step 401, a voice command of a user is recognized. The recognized voice command is converted into a command sentence. In step 402, the command sentence is interpreted to extract device data, control operation attribute data, and vocabulary command word data. In step 403, a determination of whether the command sentence is ambiguous is made by checking if the command sentence does not include the control target device data or the control operation attribute data. In step 404, if the command sentence is ambiguous, the command sentence is changed into a complete command sentence. In step 405, the current focus data stored in a memory is updated with the device data included in the complete command sentence. In step 406, the current device data, the current control operation attribute data, and the current command data are output to the outside. On the other hand, if it is determined in step 403 that the command sentence is not ambiguous, the method proceeds to step 405.

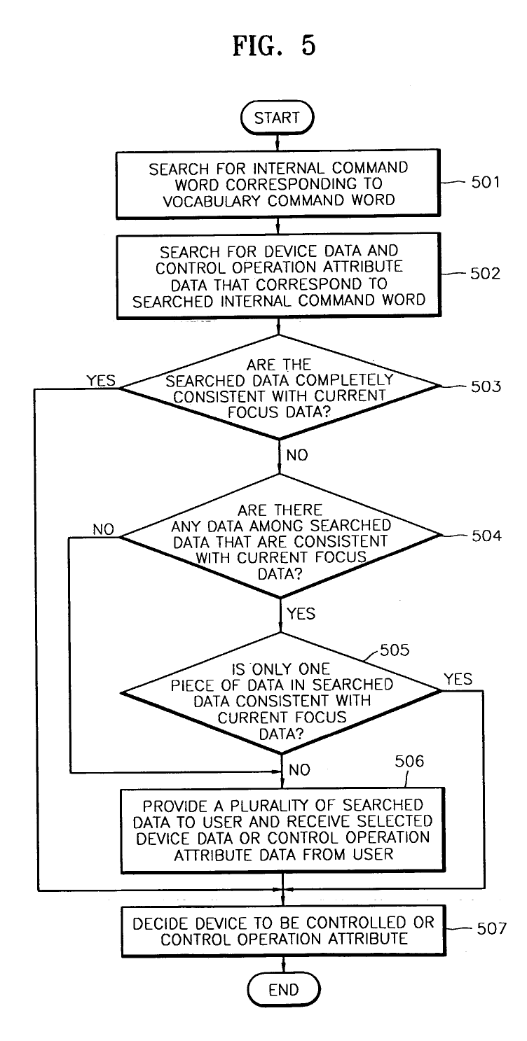

FIG. 5 is a flowchart illustrating a preferred embodiment of step 404 of FIG. 4. In step 501, an internal command word corresponding to a pre-extracted vocabulary command word is searched from a command word DB. In step 502, device data and control operation attribute data that correspond to the searched internal command word are searched from the command word DB. In step 503, it is determined whether the searched data are completely consistent with current focus data stored in a memory. If the searched data are not completely consistent with the current focus data, it is determined in step 504 whether there are any data among the searched data that are consistent with the current focus data. If consistent data exists in the searched data, it is determined in step 505 whether the number of data consistent with the current focus data is one. If a plurality of data are consistent with the current focus data, in step 506, the plurality of consistent data are provided to the user, and device data or control operation attribute data is received. In step 507, a device to be controlled or a control operation attribute is decided. In this way, a command sentence of the user is interpreted.

On the other hand, if it is determined in step 503 that the searched data are completely consistent with the current focus data, the method proceeds to step 507. If it is determined in step 504 that no searched data is consistent with the current focus data, the method proceeds to step 506. If only one piece of data is searched and found to be consistent with the current focus data, the method proceeds to step 507.

The embodiments of the present invention can be written as computer programs and can be implemented in general-use digital computers that execute the programs using a computer readable recording medium. The data structure used in the above-described embodiment of the present invention can be recorded in a computer readable recording medium in many ways. Examples of computer readable recording media include magnetic storage media (e.g., ROM, floppy disks, hard disks, etc.), optical recording media (e.g., CD-ROMs, or DVDs), and a storage medium such as a carrier wave (e.g., transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims. According to the present invention, users do not need to indicate the name of a control target device every time, and a command word to be spoken by users can be shortened. In addition, even if a new device is added to a network, addition of only command word data enables the device to be controlled and prevents a collision with voice command words for other devices.

What is claimed is:

1. A voice command interpreter used to control a predetermined electronic device, the voice command interpreter comprising:
a voice recognition unit for recognizing a voice command of a user as a command sentence for the predetermined electronic device;
a command word interpretation unit for extracting device data, control operation attributes, and a vocabulary command word from the command sentence received from the voice recognition unit;
a control target extractor for extracting device data or control operation attribute data based on the vocabulary command word data and the stored focus data if no device data or no control operation attribute data is received from the command word interpretation unit;
a focus manager for updating the focus data with the extracted device data and the extracted control operation attribute data; and
a device controller for outputting the control target device data corresponding to the focus data and the vocabulary command word data corresponding to the vocabulary command word to the outside

2. The voice command interpreter of claim 1, wherein the control target extractor searches for an internal command word corresponding to the vocabulary command word from the command word database which includes information on the devices to be controlled and information on the control operation attributes corresponding to the devices to be controlled, searches for device data and control operation attribute data that correspond to the searched internal command word from the command word database, determines whether any of the searched device data and the searched control operation attribute data is consistent with the pre-set focus data, and decides a device to be controlled and a control operation attribute based on device data and control operation attribute data that are consistent with the focus data.

3. The voice command interpreter of claim 2, wherein if the focus data corresponds to only one of the device data and the control operation attribute data, the control target extractor determines whether the device data or the control operation attribute data has only one data consistent with the focus data, and if only one data in the device data or control operation attribute data is consistent with the focus data, the control target extractor decides the consistent device data or control operation attribute data as a device to be controlled or a control operation attribute.

4. The voice command interpreter of claim 2, wherein if the focus data corresponds to only one of the device data and the control operation attribute data, the control target extractor determines whether the device data or the control operation attribute data has only one piece of data consistent with the focus data, and if a plurality of data in the device data or control operation attribute data are consistent with the focus data, the control target extractor provides the plurality of consistent device data or consistent control operation attribute data with the user and selects control target device data or selected control operation attribute data is received from the user.

5. A method of interpreting a voice command of a user in order to control a predetermined electronic device, the method comprising: recognizing a voice command of a user as a command sentence;
extracting device data, control operation attribute data, and vocabulary command word data from the command sentence;
extracting device data or control operation attribute data based on the vocabulary command word data and pre-set focus data if no device data or no control operation attribute data is extracted from the command sentence;
updating the focus data with the produced control target device data and the produced control operation attribute data; and
outputting the control target device data corresponding to the focus data and the vocabulary command word data corresponding to the vocabulary command word to the outside.

6. The method of claim 5, wherein the device data or control operation attribute data production step comprises:
establishing a command word database with device data and command data corresponding to the device data;
searching for an internal command word corresponding to the vocabulary command word from the command word database which includes information on the devices to be controlled and information on the control operation attributes corresponding to the devices to be controlled;
searching for device data and control operation attribute data that correspond to the searched internal command word from the command word database; and
determining whether any of the searched device data and the searched control operation attribute data is consistent with the pre-set focus data and deciding a device to be controlled and a control operation attribute based on device data and control operation attribute data that are consistent with the focus data .

7. The method of claim 6, wherein in the determination step, if the focus data corresponds to only one of the device data and the control operation attribute data, it is determined whether the device data or the control operation attribute data has only one data consistent with the focus data, and if only one data in the device data or control operation attribute data is consistent with the focus data, the consistent device data or control operation attribute data is decided as a device to be controlled or a control operation attribute.

8. The method of claim 6, wherein in the determination step, if the focus data corresponds to only one of the device data and the control operation attribute data, it is determined whether the device data or the control operation attribute data has only one piece of data consistent with the focus data, and if a plurality of data in the device data or control operation attribute data are consistent with the focus data, the plurality of consistent device data or consistent control operation attribute data are provided to the user, and selected control target device data or selected control operation attribute data is received from the user.

9. A computer readable recording medium which stores a computer program for executing a method of claim 5.

10. A computer readable recording medium which stores a computer program for executing a method of claim 6.

11. A computer readable recording medium which stores a data structure comprising:
a first database table including internal command word data, which associates vocabulary command words with device data and denotes the content of control of a predetermined device, and vocabulary command word data corresponding to at least one internal command word; and
a second database table including a control target device data, which denotes the internal command word data and a predetermined control target device, and a control operation attribute data, which denotes the attributes of the control of the device.
